(19) United States
(12) Patent Application Publication
(10) Pub. No.: US 2006/0002365 A1
(43) Pub. Date: Jan. 5, 2006

(54) Support node based management of cell-specific information

(76) Inventors: Tommi Heino, Palkane (FI); Arto Kangas, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/926,391

(22) Filed: Aug. 26, 2004

(30) Foreign Application Priority Data
Jun. 30, 2004 (FI) 20045256

(51) Int. Cl. H04J 3/24

(52) U.S. Cl. 370/349; 370/338; 455/446

(57) ABSTRACT

A method of managing cell-specific address information in a communication network. In the method for at least one originating cell controlled by a first radio access network node at least one target cell is defined. A request for a packet switched communication address of a second radio access network node of the target cell is generated and transferred to a support node serving the first radio access network node. In the support node the requested address is retrieved and response carrying the requested address is delivered to the first radio access network node. The first radio access network node stores the address to the first radio access network node for facilitating delivery of data packets between the originating cell and the target cell.

### FIELD OF THE INVENTION

The invention relates to telecommunications and more particularly to a method of managing cell-specific address information in a communication network, and apparatus implementing the invented method.

### BACKGROUND OF THE INVENTION

The packet domain of modern communication systems uses packet-mode techniques to transfer user data and signaling in an efficient manner. Strict separation between the radio subsystem and network subsystem is typically maintained, which allows the network subsystem to be shared by several radio access technologies.

The air interface of the radio system, on the other hand, allows signals from many users to be multiplexed over the same physical resource. Resources are given to a user upon need and are reallocated immediately thereafter. In order to accomplish this, the radio access network comprises functional elements for controlling the use of the air interface. In order to be able to appropriately control the radio resources, these functional elements need diverse cell-specific information on cell-specific groups of other cells. For circuit switched functions the specifications define exhaustively data transfer and information exchange procedures, which ensure that valid and relevant information is provided timely for the operations of the functional control elements. However, in the packet domain, some problematic deficiencies have been identified.

For example, a Network Assisted Cell Change (NACC) function reduces the service outage time at cell reselection. NACC allows support to be given to the mobile stations as system information for the target cell before the mobile station performs the cell reselection. In order to be able to provide NACC, a functional unit handling the handover of a mobile station from a source cell to a target cell needs a certain set of system information messages of the target cell. 3GPP specifies a RAN Information Management (RIM) procedure that allows delivery of information between Radio Access Network (RAN) nodes transparently to the core network. However, RIM procedures are routed via the core network, and incurring of additional load and thus increasing the risk of congestion of the interface between the radio system and the network system should be carefully avoided.

As another example, the 3^{rd} Generation Partnership Program (3GPP) standards further define network controlled cell reselection (NCCR) procedure, wherein a cell reselection is initiated for an individual mobile station by the network. In general, cell-specific load reports are delivered in specific types of circuit switched handover messages. Based on this information, load information would be available for the purpose of load-based cell reselection only in cases where the mobile station has had circuit switched connection with handovers between cells. Such dependency of packet domain operations on the circuit switched operations is not acceptable. Some advanced base station controllers allow checking of target cell loads and resource availabilities before a controlled cell change order is given. This is, however, possible only when the source and the target cells are controlled by the same base station controller. The information is equally needed in other configurations, as well.

### BRIEF DESCRIPTION OF THE INVENTION

An object of the present invention is thus to provide a method and an apparatus for implementing the method so as to solve the above problems in operations of the packet domain. The objects of the invention are achieved by a method and an arrangement which are characterized by what is stated in the independent claims. The preferred embodiments of the invention are disclosed in the dependent claims.

The invention is based on the idea of facilitating exchange of cell-specific information as much as possible by means of direct packet switched communication between the radio access network nodes that control the relevant cells. This is accomplished by storing address information on at least one other cell into a radio access node that controls the use of the radio resources in one cell. Since the number of cells in mobile communication systems is typically big, a procedure that allows automatic management of the address information in the cell is established. The mechanism is arranged to the interface between the radio access network and the core network, and therefore optimizes the signaling load required for the desired functionality.

Based on the stored cell-specific information, any subsequent information may be exchanged directly between the nodes controlling the cells without congesting the essential core network elements and interfaces. Some further advantages of the invention are described along with the preferred embodiments.

### BRIEF DESCRIPTION OF THE DRAWINGS

In the following the invention will be described in greater detail by means of preferred embodiments with reference to the attached drawings, in which

FIG. 1 illustrates the functional architecture of a communication system;

FIG. 2 illustrates alternative locations of a PCU;

FIG. 3a illustrates a configuration of a group of neighboring cells;

FIG. 3b illustrates the logical configuration of base station systems including the cells of FIG. 3a;

FIG. 4 illustrates a protocol stack in Gb interface;

FIG. 5a illustrates a configuration of two base station systems BSS1 and BSS2 controlled by one SGSN:

FIG. 5b illustrates an embodiment of the present invention in the configuration of FIG. 5a;

FIG. 6 illustrates an exemplary signaling sequence in the configuration of FIG. 5a;

FIG. 7a illustrates a configuration of two base station systems BSS1 and BSS2 controlled by two serving GPRS support nodes SGSN1 and SGSN2:

FIG. 7b illustrates an embodiment of the present invention in the configuration of FIG. 7a;

FIG. 8 illustrates an exemplary signaling sequence in the configuration of FIG. 7a;

FIG. 9 illustrates the functional elements of a packet control unit.

### DETAILED DESCRIPTION OF THE INVENTION

The present invention is applicable to different telecommunications systems that enable packet data transmission between mobile data terminals and external data networks, e.g. in the GSM system together with the general packet radio service (GPRS) or in new third-generation telecommunications systems such as the UMTS (Universal Mobile Telecommunications System) or the WCDMA. In the following, the preferred embodiments of the invention are described by means of the GPRS/GSM radio system without limiting the invention to this particular radio system.

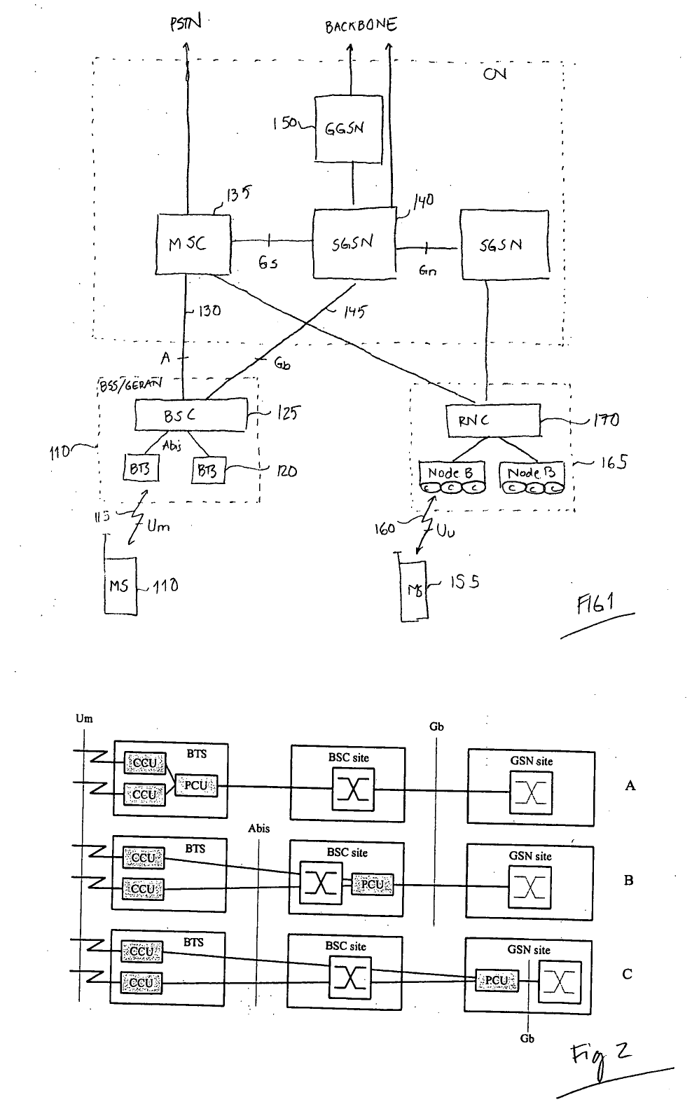

The block chart of FIG. 1 illustrates the functional architecture of a communication system. The first leg of the system illustrates a mode of operation of the mobile station (MS) 100 connected to the Core Network (CN) 105 via General Packet Radio Service (GPRS) system, the GSM system (Global System for Mobile communications) acting as a Radio Access Network (RAN). Generally, the basic structure of a GSM network comprises two parts: a base station system (BSS) 110 and a network subsystem (NSS). The GSM BSS communicates with mobile stations (MS) 100 via radio connections over a radio interface Um 115. In the base station system BSS 110 each cell is served by a base transceiver station (BTS) 120. The base station 120 is connected to a base station controller (BSC) 125, which controls the radio frequencies and channels used by the base station. The base station controller BSC 125 is connected over an A-interface 130 to a mobile switching centre (MSC) 135, i.e. as a part of GSM NSS to the core network NC 105 of the system.

The Serving GPRS Support Node (SGSN) 140 keeps track of the location of individual mobile stations and performs security functions and access control. The SGSN 140 is connected to the GSM base station system through the Gb interface 145. The Gateway GPRS Support Node (GGSN) 150 provides interworking with packet data networks, and is connected with SGSNs via an IP-based packet domain PLMN backbone network.

In order to use GPRS services, an MS shall first make its presence known to the network by performing a GPRS attach. This makes the MS available for SMS over GPRS, paging via the SGSN, and notification of incoming packet data. In order to send and receive packet data by means of GPRS services, the MS shall activate the Packet Data Protocol context that it wants to use. This operation makes the MS known in the corresponding GGSN, and interworking with data networks can commence.

A serving GPRS support node 140 (SGSN) is arranged to serve a mobile station by sending or receiving packets via the BSS. Each support node SGSN manages the packet data service in the area of one or more cells in a cellular packet radio network. A mobile station 10, which is in a cell, communicates with the BSS 110 over the radio interface Um 115 and further through the Gb interface 145 with the SGSN 140 to the service area of which the cell belongs. This mode of operation of the MS, when connected to the Core Network via GERAN and the A and/or Gb interfaces, is called A/Gb mode. GERAN refers to GSM/EDGE radio access network which includes GPRS and EDGE technologies.

The other leg of the system illustrates a mode of operation of the mobile station (MS) 155 connected to the Core Network (CN) 105 via a UMTS terrestrial radio access network UTRAN. The air interface between the UTRAN and the user equipment UE is called the Uu interface 160.

The UTRAN comprises one or more radio network subsystems (RNS) 165, (also called radio access networks) that are connected to the core network CN 105 over an lu interface. Each RNS 165 is responsible for the resources of its cells. A radio network subsystem RNS 165 consists of a radio network controller (RNC) 170, and a multiplicity of nodes B 175, logically corresponding to base stations of traditional cellular systems.

The radio network controller RNC is the network node responsible for the control of the radio resources. The radio network controller RNC 170 interfaces the core network CN and also terminates the RRC protocol (Radio Resource Control) that defines the messages and procedures between the mobile and the UTRAN. It logically corresponds to a base station controller in the GSM systems. On connections between the mobile station 155 and the UTRAN, RNC 170 is the serving radio network controller. As shown in FIG. 1, RNC 170 is connected to two CN nodes (MSC/VLR 135 and SGSN 140). In some network topologies it is also possible that one RNC is connected to one or more than two CN nodes which may be of similar or different type. For example, an RNC can be connected to several SGSNs. This mode of operation of the MS, when connected to the Core Network via GERAN or UTRAN and the lu interface is called the lu mode.

It should be noted that only elements and units essential for understanding the invention are illustrated in FIG. 1. For a person skilled in the art it is clear that a communication system typically comprises a plurality of elements not shown in FIG. 1.

More precisely, the specification defines the Gb interface to exist between a packet control unit (PCU) and a SGSN. The packet control unit is a functional unit responsible for various protocols in the GPRS MAC (Medium Access Control) and RLC (Radio Link Control) layers. These functions include establishment of RLC blocks for downlink transmission (towards the mobile station), de-assembly of blocks for uplink transmission (towards the network), timing of PDCH (Packet Data Channel), channel access control functions (access request and access grants) and management functions of the radio channel, such as power control, allocation and release of radio channels, broadcast of control information, etc.

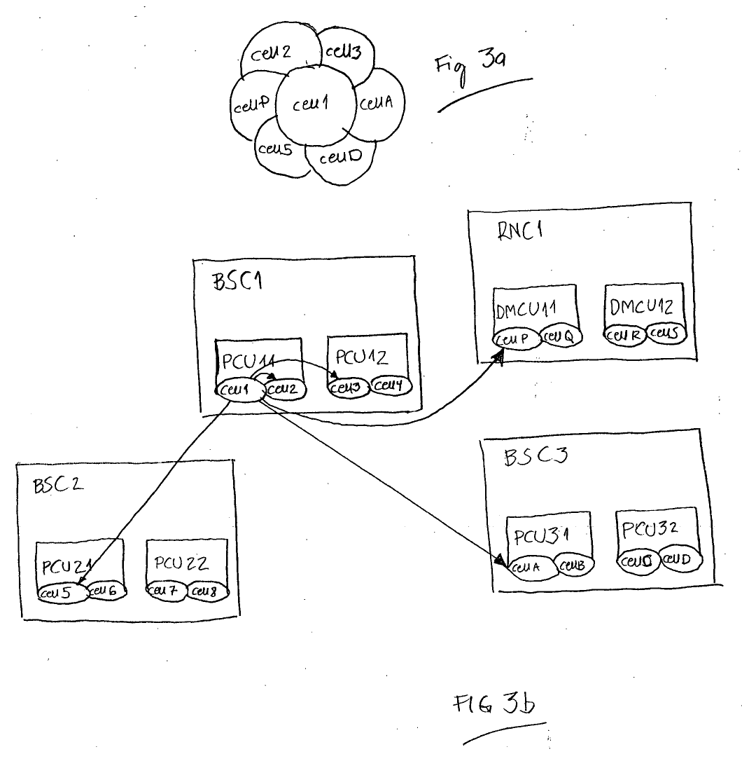

The packet control unit is connected to a channel codec unit (CCU) of a base station by means of an Abis interface. The functions of the channel codec unit include channel coding functions (including co-directional error correction FEC and interleaving) and measuring functions related to the radio channel. The channel codec unit also establishes GPRS radio blocks, i.e. GPRS packets in which the data and signaling information are sent over the radio interface Um. The channel codec unit is always located in a base station, but the PCU has a variety of alternative locations, as shown in FIG. 2. When the packet control unit is positioned remote from the base station, data is transmitted between the packet control unit and channel codec units over the Abis interface using PCU frames, which are extensions of the TRAU (Transcoder/rate Adaptor Unit) frames. Both GPRS data and GPRS MAC/RLC control signals are transmitted in the PCU frames.

Option A of FIG. 2 illustrates a configuration where the packet control unit PCU and the channel codec units are situated in a base station BTS. Option B illustrates a configuration where the packet control unit PCU is situated at the base station controller BSC site, for example implemented as an adjunct unit to the BSC. Option C illustrates a configuration where the packet control unit PCU is positioned at the SGSN site. In configurations B and C the PCU is referred to as a remote PCU. The dotted line switch symbol refers to a packet-switching function, and the solid line switch symbol refers to a circuit-switching function, and the Um, Abis, and Gb interfaces are shown accordingly.

The air interface of the system in FIG. 1 allows signals from many users to be multiplexed over the same physical resource. Resources are given to a user upon need and reallocated immediately thereafter. During its operation a packet control unit in a radio access network (RAN) node, which unit is arranged to control the use and integrity of the radio resources in a communication system, needs information regarding a defined group of other RAN cells. In the following, an embodiment of the invention is described by using PCU operations and related communication as an example. As explained above, in A/Gb mode the element controlling the BTS cells is PCU and correspondingly in lu mode the element controlling the node B cells is RNC. The scope of protection should therefore not be interpreted merely through the A/Gb mode terminology of the specific embodiment. For example, depending on the mode of operation, the PCU could be replaced with an RNC element in the description.

The type of information to be exchanged between the radio access nodes varies according to the functionality necessitating the information exchange. Correspondingly, the criterion of defining the group of cells regarding which the information is exchanged also varies for different functionalities. As an example, a network controlled cell reselection (NCCR) procedure is discussed in more detail. A mobile station may receive neighboring cell system information on a packet associated control channel (PACCH). The neighboring cell system information is contained in one or more instances of a PACKET NEIGHBOUR CELL DATA message. A mobile station, which receives this information stores the last received set of the information for at least one cell. The received system information is valid for 30 seconds and can be used for initial access when entering a designated neighbor cell.

When a cell reselection is initiated by the network, the cell change procedure is started by sending a PACKET CELL CHANGE ORDER message to the mobile station on the packet common control channel (PCCCH) or packet associated control channel (PACCH). The PACKET CELL CHANGE ORDER message comprises characteristics of the new cell and a variety of relevant parameters. The PACKET CELL CHANGE ORDER message may also comprise the CONTAINER_ID referring to the one included in the received instances of the PACKET NEIGHBOUR CELL DATA message. This is in order to map the cell identity to the container identity for which neighbor cell information was received in the PACKET NEIGHBOUR CELL DATA messages. In managing the procedure, the PCU needs to know the status of traffic load in cells that are close to the current location of the mobile station. In terms of the present invention, the type of information in this example thus comprises cell load reports, and the criterion for choosing relevant cells for the group of cells is that the cell should be a neighbor cell to the cell currently serving the mobile station.

As a further example of functionalities necessitating exchange of information between RAN nodes, a base station system GPRS protocol (BSSGP) flush procedure can be mentioned. BSSGP is a protocol that conveys routing information and quality of service related information between a base station system (BSS) and a serving GPRS support node (SGSN). BSSGP supports the BSSGP virtual connections (BVC) so that each cell always has one BVC over the Gb interface, and supports both cell-specific (BVC) and MS-specific flow control. On receipt of a downlink logical link control (LLC) protocol data unit, a BSS will either delete queued LLC protocol data units of a defined logical link, identified by a temporary logical link identity (TLLI), or move the queued LLC protocol data units from an old to a new BVC. In a case where the mobile station has an existing BSS context and the BSS is not able to move the queued LLC protocol data units, the BSS moves the BSS context from the old to a new BVC, even if the new BVC is not able to offer the same quality of service (QoS) parameters. The type of information to be exchanged during flush operations comprises LLC protocol data units and/or QoS parameters, and the group of relevant cells comprises at least one target cell at cell change.

For a person skilled in the art it is thus clear that the invented solution can be applied to various types of information and differently chosen groups of cells without deviating from the scope of protection.

In the following an embodiment based on NCCR is described in more detail. According to the GSM/3G specifications, the BSS and a cell within the BSS are identified by adding a Cell Identity (C1) to the location area or routeing area identification. The C1 is of fixed length with 2 octets and it can be coded using a full hexadecimal representation. The Cell Global Identification is the concatenation of the Location Area Identification and the Cell Identity. Cell Identity is unique within a location area. Neighboring relates herein to criterion for choosing the relevant cells for the load reporting functionality, and generally refers to a cell the area of which is limited to or overlaps the area of the cell concerned.

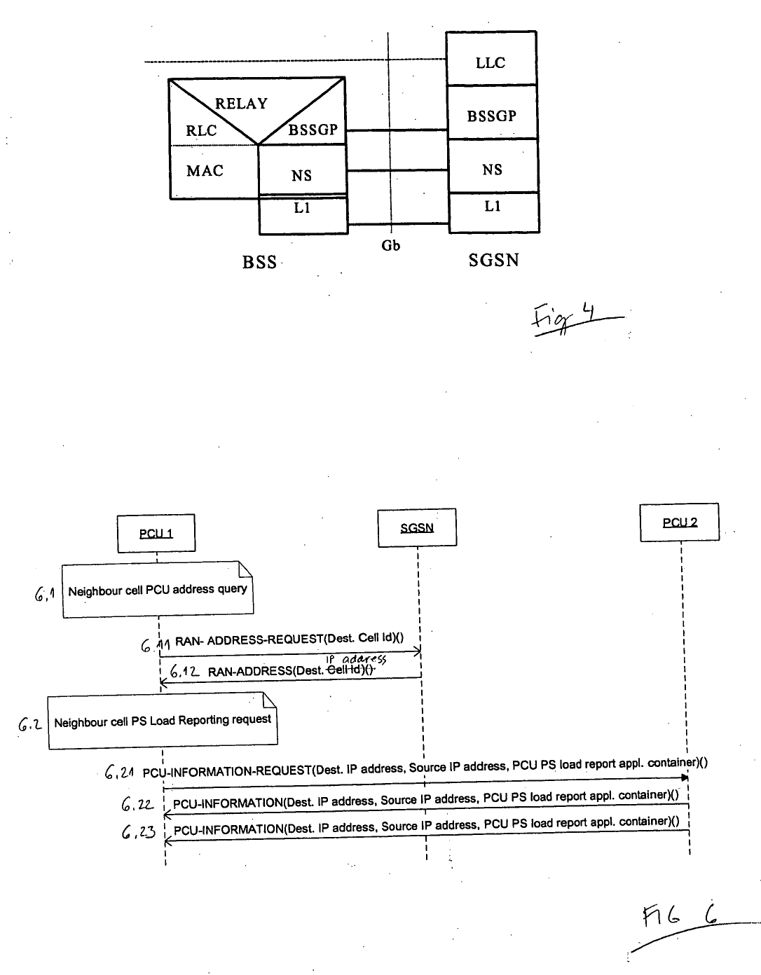

FIG. 3a illustrates configuration of a group of neighboring cells, and FIG. 3b illustrates the logical configuration of base station systems including these cells. In the embodiment of FIGS. 3a and 3b the units responsible for controlling packets are shown according to option B of FIG. 2, i.e. as located in BSC sites. BSC1 comprises two packet control units, PCU11 and PCU12. PCU11 controls cells cell1 and cell2, and PCU12 controls cells cell3 and cell4. BSC2 also comprises two packet control units, PCU21 and PCU22. PCU21 controls cells cell5 and cell6, and PCU22 controls cells cell7 and cell8. BSC3 also comprises two packet control units, PCU31 and PCU32. PCU31 controls cells cellA and cellB, and PCU32 controls cells cellC and cellD. FIG. 3b shows further a RNC comprising two UTRAN packet control elements, here denoted as DMCU, that correspond to GERAN PCUs. RNC comprises two packet control units, RMCU11 and RMCU12. RMCU11 controls cells cellP and cellQ, and RMCU12 controls cells cellR and cellS.

In the beginning the mobile station is in cell1 of BSC1, and as can be seen in FIG. 3a, its neighboring cells are cell2 and cell3 of BSC1, cell5 of BSC2, cellA of BSC3 and cellP. In order to be able to properly implement NCCR from cel11, PCU11 should know the load status in each of these neighboring cells. A prior art PCU knows the neighboring cell IDs, but any other address information is not inherently stored in the packet control units.

FIG. 4 illustrates the peer protocols across the Gb-interface. The network service (NS) transports BSSGP PDUs between a BSS and an SGSN. The primary functions of the BSSGP include the provision by an SGSN to a BSS of radio related information used by the RLC/MAC function in the downlink, the provision by a BSS to an SGSN of radio related information derived from the RLC/MAC function in the uplink; and the provision of functionality to enable two physically distinct nodes, an SGSN and a BSS, to operate node management control functions.

According to the concepts developed in International Telecommunication Union Telecommunication Standardization Sector (ITU-T) Recommendation X.200, the communication between adjacent layers and the services provided by the layers are distributed by use of abstract service primitives. Primitives consist of commands and their respective responses associated with the services requested of another layer.

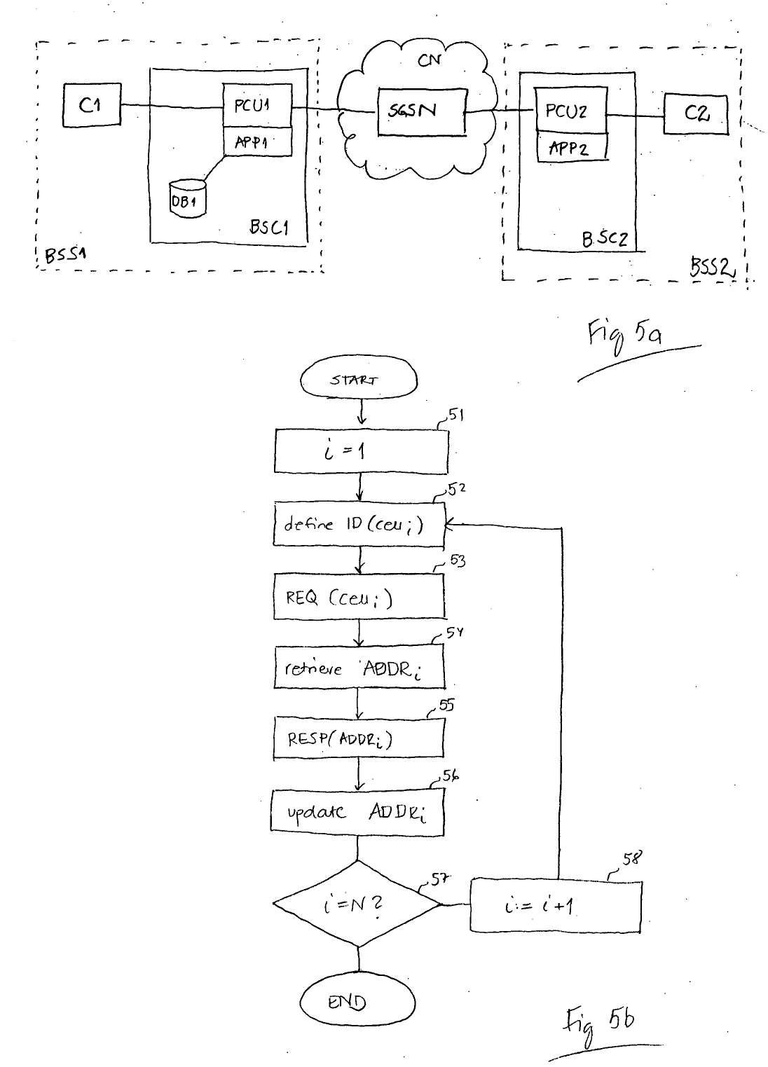

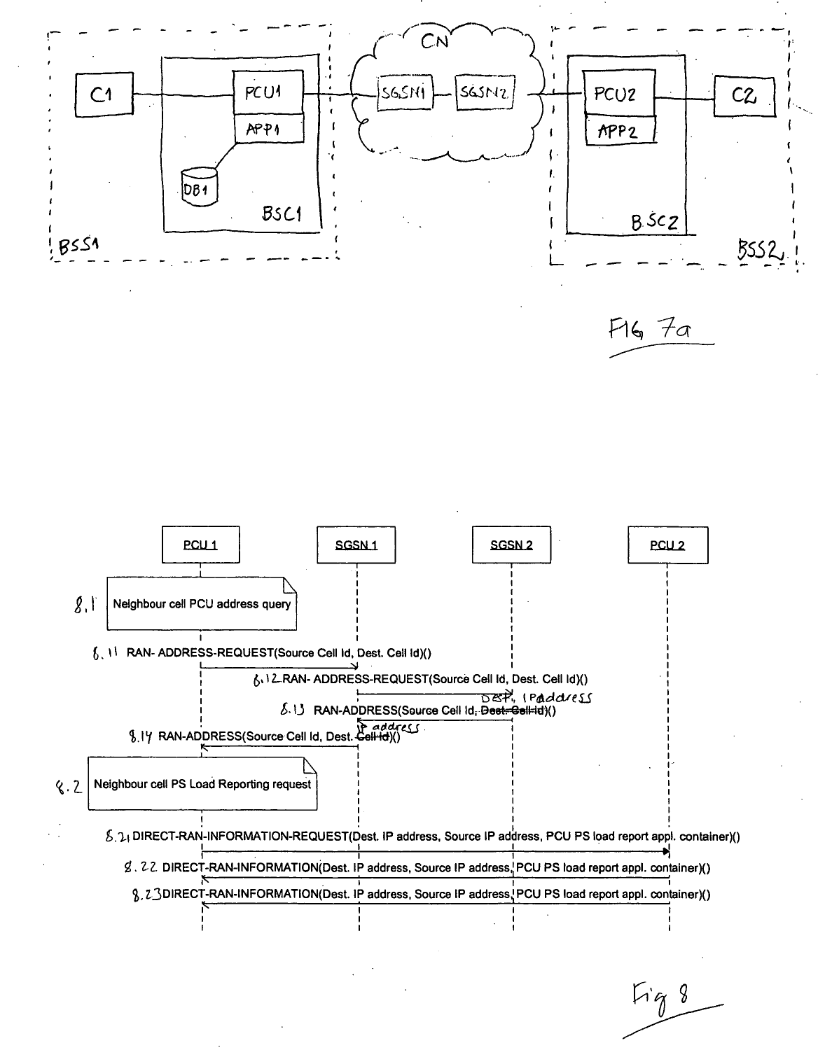

In this context, FIG. 5a now illustrates a configuration of two separate base station systems BSS1 and BSS2, and FIG. 5b illustrates an embodiment of the present invention in the configuration of FIG. 5a. The embodiment of FIG. 5a illustrates option B of FIG. 2, i.e. a packet control unit PCU1 responsible for cell C1 is an adjunct unit of the base station controller BSC1 of BSS1. Correspondingly, a packet control unit PCU2 responsible for cell C2 is an adjunct unit of the base station controller BSC2 of BSS2. Base station systems BSS1 and BSS2 are interconnected via a core network CN. In FIG. 5a, a configuration with a serving support node SGSN serving both base station controllers BSC1 and BSC2 is shown as an example. A cell may correspond to a base station BTS or a node B. Alternatively a base station or a node B site may comprise several cells that are identified with different cell IDs.

An application APP1 in PCU1 of BSS1 first (step 51) defines a group of cells (step 52), comprising one or more (up to N) radio cells of the communication system, that are, according to a defined selection criterion, relevant to a cell C1. The selection criterion may be, for example that the cells cellᵢ, i=1, . . . ,N are neighbor cells of C1. PCU1 sends (step 53) a message comprising the cell identification (ID) of the target cell C2 to the SGSN1 controlling PCU1. When the PDU has reached the SGSN1, the SGSN1 retrieves (step 54) the IP address of PCU2 and sends (step 55) a message comprising the address to PCU1. APP1 is further connected to a database DB1 in BSC1, and in response to receiving the address information element updates the address information to the database DB1 (step 56). Hereafter the application checks (step 57) whether there exists any other relevant cells. If yes, the procedure is repeated (step 58) for each of the relevant cells. When address information on all N cells is updated, the procedure will terminate.

For the purpose of utilizing the capability of the serving core network element to work out the routing information to the packet control unit PCU2 of cell C2, in this embodiment an example of a new service primitive is introduced in the BSSGP. FIG. 6 illustrates a signaling sequence utilizing this exemplary service primitive. It should be noted that the primitive and the signaling messages are shown to illustrate the logical elements exchanging the information and the information content of the exchanged messages. The scope of protection is not limited to the terms and expressions used in the description. The first phase is the neighbor cell PCU address query (6.1) that is initiated with a RAN-ADDRESS REQUEST—message (6.11). The message carries the identification of the target cell. SGSN1 receives the signal, and retrieves the IP address of PCU2 from its records, includes it in the RAN-ADDRESS—message (6.11) and transmits the message to PCU1.

The second phase illustrates packet switched communication for exchanging load report information from the target cell (6.2). The procedure is initiated by a DIRECT-RAN-INFORMATION-REQUEST—message (6.21) from PCU1 to PCU2. The message includes the IP address of a packet unit controlling the source cell, includes the IP address of a packet unit controlling the target cell, and a PCU PS load report application container carrying an application element to be interpreted by a corresponding application in the receiving end. Reception of the application element in PCU2 triggers delivery of load reports of the target cell from PCU2 to PCU1. The load reports are carried in DIRECT-RAN-INFORMATION—messages (6.22 and 6.23) that include the IP address of PCU2, the IP address of PCU1 and the PCU PS load report application container.

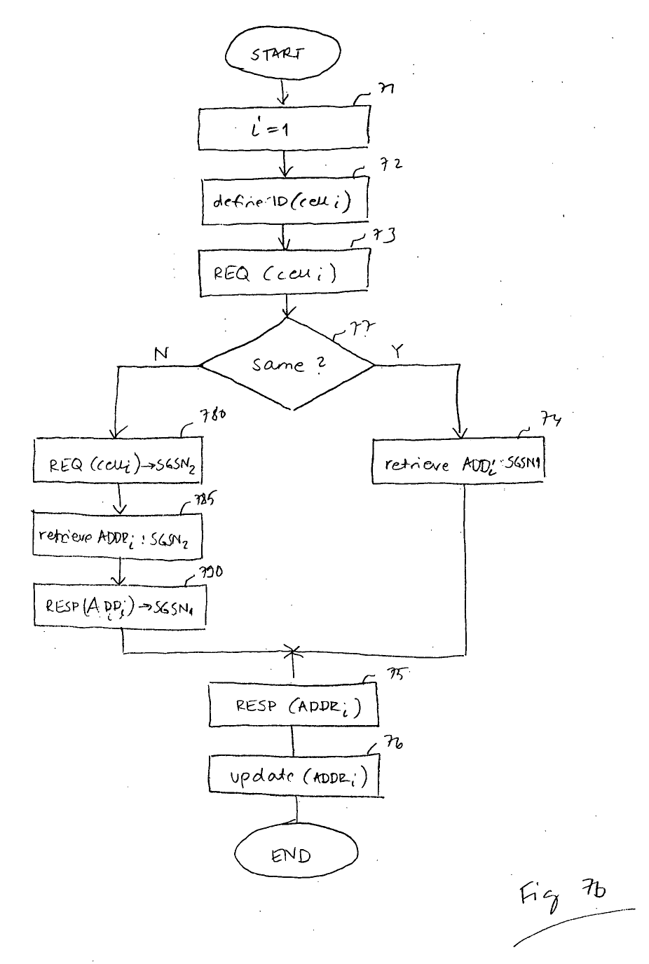

The first embodiment of FIG. 5a illustrates a simple case where the packet control units are controlled by the same SGSN. FIG. 7a illustrates another embodiment of the invention where the configuration includes two separate base station systems BSS1 and BSS2. Correspondingly, FIG. 7b illustrates an embodiment of the present invention in the configuration of FIG. 7a. In FIG. 7a, a configuration with two serving support nodes SGSN1 and SGSN2 serving base station controllers BSC1 and BSC2, correspondingly, is shown as an example.

Steps 71 to 76 correspond directly with steps of FIG. 5. However, after step 73 of PCU1 sending a message comprising the cell identification (ID) of the target cell C2 to SGSN1 controlling it, SGSN1 determines (step 77) from the Routeing Area Identity of the cell ID, whether or not it is connected to BSS2. If SGSN1 is not directly connected to BSS2, then it shall use RAI to forward the requesting message to SGSN2 via the Gn interface (step 780). SGSN2 retrieves (step 785) the IP address of PCU2 and sends (step 790) a response comprising the address to SGSN1. SGSN2 determines from the Routeing Area Identity of the destination BSS address, whether or not it is connected to BSS1. If SGSN2 is not directly connected to BSS1, it shall use the RAI to route the message to SGSN1 via the Gn interface sends the message to BSS2 via the Gb interface based on the C1 of the destination address.

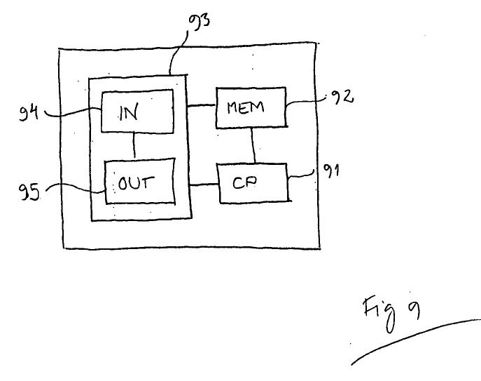

FIG. 8 illustrates a signaling sequence related to this second embodiment of the present invention. The first phase is again the neighbor cell PCU address query (8.1) that is initiated with a RAN-ADDRESS REQUEST message (8.11) from PCU1 to SGSN1. The message carries the identification of the target cell. SGSN1 receives the message, and determines from the Routeing Area Identity of the target cell ID that it is connected to BSS2. SGSN1 sends the message (8.12) to BSS2 via the Gb interface on the basis of the C1 of the destination address. In response to the application information in the message, SGSN2 retrieves the IP address of PCU2 and includes it into a RAN-ADDRESS—message (8.13). The SGSN2 determines from the Routeing Area Identity of the destination BSS address, whether or not it is connected to BSS1. If the SGSN2 is not directly connected to BSS1, then it shall use the RAI to route the message to SGSN1 via the Gn interface. The SGSN1 sends the RAN-ADDRESS—message (8.14) to PCU1 via the Gb interface on the basis of the C1 of the destination address.

The second phase (8.2) corresponds directly to the second phase of FIG. 6. The procedure is initiated by a DIRECT-RAN-INFORMATION-REQUEST-message (6.21) from PCU1 to PCU2, and the subsequent load reports are carried in DIRECT-RAN-INFORMATION—messages.

It should be noted that only signaling messages essential for illustrating the present embodiment are shown. For a person skilled in the art it is clear that operations in communication networks involve a lot of signaling, not explicitly shown herein.

The advantage of the present invention is that it allows a mechanism to automatically manage cell-specific address information in radio access network nodes. Furthermore, by means of the cell-specific address information, data packets may be exchanged between packet control units without incurring additional load to the Gb/lu interface, and/or to the core network elements between the packet control units. This provides for a variety of further advantageous applications, for example the possibility to balance loads between neighboring cells independently, without dependencies on any of the circuit switched procedures of the A interface. The mechanism may require introduction of a new primitive to the interface between the radio access network and the core network, but thereafter provides the above advantages with an optimal incurred signaling load to the core network.

The application may be arranged to first request and store the cell-specific address information for each of the target cells, and thereafter update the information according to a defined plan. The plan may comprise, for example, periodic updates, wherein the address information is requested and updated after defined time periods. The plan may also comprise event-based updates, or a combination of these.

The invention also allows dynamic definition of groups for a cell. For example, configurations may change: new neighboring cells may be installed and/or some existing cells may be deleted. The application may be further arranged to receive an indication on a change in the definition of the group of target cells and, in response to the indication, to update the cell-specific information automatically.

The selection criterion may be cell-specific or may be defined as a rule applicable to two or more cells. In order to avoid conflicting definitions, ubiquitous prevalence between possibly overlapping definitions is preferably defined.

The implementation of the described mechanisms in a packet control unit is illustrated with reference to FIG. 9. FIG. 9 provides a description of a packet control unit that performs one or more of the previously described server functions. The packet control unit comprises processing means 91, an element that comprises an arithmetic logic unit, a number of special registers and control circuits. Connected to the processing means are memory means 92, a data medium where computer-readable data or programs or user data can be stored. The memory means typically comprise memory units that allow both reading and writing (RAM), and a memory whose contents can only be read (ROM). The unit also comprises an interface block 93 with input means 94 for inputting data for internal processing in the unit, and output means 95 for outputting data from the internal processes of the unit. Examples of said input means comprise a plug-in unit acting as a gateway for information delivered to its external connection points. Examples of said output means include a plug-in unit feeding information to the lines connected to its external connection points. The processing means 91, memory means 92, and interface block 93 are electrically interconnected for performing systematic execution of operations on the received and/or stored data according to the predefined, essentially programmed processes of the unit. In a solution according to the invention, the operations comprise a functionality for implementing the operations of the packet control unit described above.

It will be obvious to a person skilled in the art that, as technology advances, the inventive concept can be implemented in various ways. The invention and its embodiments are not limited to the examples described above but may vary within the scope of the claims.

1. A method of managing cell-specific address information in a communication network comprising a core network and a radio access network, said method comprising:
defining in a first radio access network node for at least one originating cell controlled by the first radio access network node at least one target cell;
generating in the first radio access network node a request for a packet switched communication address of a second radio access network node of the at least one target cell;
transferring the request to a support node serving the first radio access network node;
retrieving, in response to receiving the request in the support node, the packet switched communication address of the second radio access network node of the at least one target cell;
transferring a response including the retrieved packet switched communication address to the first radio access network node;
storing the received packet switched communication address of the second radio access network node in the first radio access network node for facilitating delivery of data packets between the at least one originating cell and the at least one target cell.

2. The method of claim 1, wherein said step of defining comprises defining the at least one target cell on a basis of at least one selection criterion.

3. The method of claim 2, wherein the at least one selection criterion defines that the at least one target cell is a neighboring cell to a current cell.

4. The method of claim 1, wherein said step of retrieving comprises retrieving the packet switched communication address of the second radio access network node according to an identification of the at least one target cell.

5. The method of claim 1, further comprising detecting a change in the target cell address information; and
transferring a new request to the at least one target cell.

6. The method of claim 1, further comprising transferring a new request to the at least one target cell periodically.

7. The method of claim 1, the retrieving step comprising:
sending a request from the support node serving the first radio access network node to the support node serving the second radio access network node;
receiving the requested packet switched communication address from the support node serving the second radio access network node.

8. A functional unit of a first radio access network node in a communication system comprising a radio access network and a core network, said functional unit comprising:
defining means for defining for at least one originating cell controlled by the first radio access network node at least one target cell;
generating means for generating a request for a packet switched communication address of a second radio access network node of the at least one target cell;
transferring means for transferring the request to a support node serving the first radio access network node;
receiving means for receiving a response including the requested packet switched communication address;
storing means for storing the received packet switched communication address of the second radio access network node in the first radio access network node for facilitating delivery of data packets between the at least one originating cell and the at least one target cell.

9. The functional unit of claim 8, wherein said defining means is configured to define the at least one target cell on a basis of at least one selection criterion.

10. The functional unit of claim 9, wherein the selection criterion defines the at least one target cell to be a neighboring cell to a current cell.

11. The functional unit of claim 8, wherein said generating means is configured to include, in the request, an identification of the at least one target cell.

12. The functional unit of claim 8, wherein:
said receiving means is configured to receive an indication of a change in the at least one target cell address information; and
said generating means is configured to generate a new request to the at least one target cell, in response to receiving said indication.

13. The functional unit of claim 8, wherein said generating means is configured to generate a new request to the at least one target cell periodically.

14. The functional unit of claim 8, wherein said retrieving means is configured to:
send a request from the served first radio access network node to the support node serving the second radio access network node; and
receive the requested packet switched communication address from the support node serving the second radio access network node.

15. A support node of a core network node in a communication system comprising a radio access network and a core network, said functional unit comprising:
receiving means for receiving a request for a packet switched communication address of a second radio access network node of a target cell;
retrieving means for retrieving, in response to receiving the request, the packet switched communication address of the second radio access network node of the target cell;
generating means for generating a response including the retrieved packet switched communication address;
transferring means for transferring the response to a first radio access network node.

16. A radio access network node including a functional unit comprising:
defining means for defining for at least one originating cell controlled by a first radio access network node at least one target cell;
generating means for generating a request for a packet switched communication address of a second radio access network node of the at least one target cell;
transferring means for transferring the request to a support node serving the first radio access network node;
receiving means for receiving a response including the requested packet switched communication address;
storing means for storing the received packet switched communication address of the second radio access network node in the first radio access network node for facilitating delivery of data packets between the at least one originating cell and the at least one target cell.

17. A core network node including a functional unit comprising:
receiving means for receiving a request for a packet switched communication address of a second radio access network node of a target cell;
retrieving means for retrieving, in response to receiving the request, the packet switched communication address of the second radio access network node of the target cell;
generating means for generating a response including the retrieved packet switched communication address;
transferring means for transferring the response to a first radio access network node.

18. A computer program product, executable on a computer, wherein execution of the computer program product in a packet control unit of a radio access network node causes the unit to:
define for at least one originating cell controlled by a first radio access network node at least one target cell;
generate a request for a packet switched communication address of a second radio access network node of the at least one target cell;
transfer the request to a support node serving the first radio access network node;
receive a response including the requested packet switched communication address;
store the received packet switched communication address of a second radio access network node in the first radio access network node for facilitating delivery of data packets between the at least one originating cell and the at least one target cell.

19. A computer program product, executable on a computer, wherein execution of the computer program product in a core network support node causes the support node to:
receive a request for a packet switched communication address of a second radio access network node of a target cell;
retrieve, in response to receiving the request, the packet switched communication address of the second radio access network node of the target cell;
generate a response including the retrieved packet switched communication address;
transfer the response to a first radio access network node.
